(19) United States
(12) Patent Application Publication
(10) Pub. No.: US 2021/0296028 A1
(43) Pub. Date: Sep. 23, 2021

(54) HIGH TEMPERATURE RESISTANT NEODYMIUM-IRON-BORON MAGNETS AND METHOD FOR PRODUCING THE SAME

(71) Applicant: JL MAG RARE EARTH CO., LTD., Jiangxi (CN)

(72) Inventors: Huayun Mao, Ganzhou, Jiangxi (CN); Lujun Liu, Ganzhou, Jiangxi (CN); Yijie Zhan, Ganzhou, Jiangxi (CN)

(73) Assignees: JL MAG RARE EARTH CO., LTD., Ganzhou, Jiangxi (CN); JL MAG RARE EARTH CO., LTD., Ganzhou, Jiangxi (CN)

(21) Appl. No.: 16/315,123

(22) PCT Filed: Oct. 13, 2017
(86) PCT No.: PCT/CN2017/106066

§ 371 Date: Jan. 3, 2019

(30) Foreign Application Priority Data
Aug. 9, 2017 (CN) 201710675667.5

(51) Int. Cl. H01F 1/057; H01F 41/02

(52) U.S. Cl. CPC H01F 1/0576; H01F 41/0293; H01F 1/0577

(57) ABSTRACT

Provided is a neodymium-iron-boron magnet, obtained by processing neodymium-iron-boron raw material powders coated with modified powders, wherein the modified powders comprise heavy rare earth element oxide powders and/or heavy rare earth element fluoride powders, specially, heavy rare earth fluoride or oxide powders are used to coat on the surface of the magnetic powders, so that diffusion occurs simultaneously during the subsequent sintering. In addition, during the sintering process, the heavy rare earth oxide or fluoride powders coated on the surface of the magnetic powders substitute part of the light rare earth and the heavy rare earth is absorbed by the magnets, thereby increasing coercive force and effectively inhibiting the reduction of the residual magnetism. In the present disclosure, by using small amount of heavy rare earth element, the coercive force of magnets is increased, which saves rare earth metal sources and production cost.

### CROSS REFERENCE TO RELATED APPLICATIONS

This application is a US National Phase application based upon PCT Application No. PCT/CN2017/106066, which claims the priority of Chinese Patent Application No. 201710675667.5, filed on Aug. 9, 2017, and titled with “HIGH TEMPERATURE RESISTANT NEODYMIUM-IRON-BORON MAGNETS AND METHOD FOR PRODUCING THE SAME”, and the disclosures of which are hereby incorporated by reference.

### FIELD

The present disclosure belongs to the field of rare earth permanent magnet material, relates to a neodymium-iron-boron magnet and a method for producing the same, especially to a high temperature resistant neodymium-iron-boron magnet and a method for producing the same.

### BACKGROUND

Neodymium-iron-boron magnet is also called Neodymium magnet, with a chemical formula of Nd₂Fe₁₄B. It is an artificial permanent magnet and also the permanent magnet with the strongest magnetic force so far as well, which has a maximum magnetic energy product (BHmax) 10 times higher than that of ferrite. Under condition of bare magnet, the magnetic force of which can reach about 3500 Gauss. At present, sintering method is usually used in industry to produce neodymium-iron-boron permanent magnetic material. For example, Wei Wang et al. disclosed a technological process of preparing neodymium-iron-boron permanent magnetic material by sintering method in “Effects of key process parameters and alloying on magnetic properties and mechanical properties of sintered magnets”, comprising steps of: dosing, melting, steel ingot decrepitation, pulverizing, hydrogen decrepitation ultrafine powder, powder orientation compression molding, vacuum sintering, separation, electroplating and so on. Neodymium-iron-boron magnets have advantages of high price/performance ratio, small volume, light weight, good mechanical properties, strong magnetic properties, high energy density and so on, which lead to widely use of neodymium-iron-boron permanent magnetic materials in modern industry and electronic techniques, being honored as “king of magnets” in the field. Thus, preparation and expansion of neodymium-iron-boron magnets have attracted the constant attention in the field.

Especially in recent years, as the magnet with the best performances in permanent magnets, R—Fe—B based rare earth sintered magnet, in which Nd₂Fe₁₄B is the main phase, is widely used in hard disk driven voice coil motor (VCM), servo motor, inverter air conditioner, motor used in hybrid vehicle and so on. In applications of various motors, the magnets not only need to have high coercive force, but also excellent heat resistance to adapt to high-temperature service environments.

Conventional art for improving coercive force of R—Fe—B based rare earth sintered magnets is by adding heavy rare earth elements RH in raw materials so that the light rare earth elements LH (mainly Nd and Pr) in R₂Fe₁₄B phase are substituted with heavy rare earth elements RH, therefore, improving the magnetic anisotropy (physical quantity that determines the nature of coercive force) of crystals in R₂Fe₁₄B phase. However, in R₂Fe₁₄B phase, magnetic moment of light rare earth elements RL is higher than that of the heavy rare earth elements RH, the more light rare earth elements RL is substituted with the heavy rare elements RH, the more remanent flux density Br decreases. On the other hand, due to heavy rare earth elements are scarce resource, it is necessary to reduce the consuming amount of it.

In recent years, dysprosium diffusion technique has drawn extensive attention of the industry, that is, by methods of coating, depositing, plating, spraying or pasting, heavy rare earth element is coated on the surface of magnet, followed by diffusion; or after heavy rare earth element is evaporated, a layer of heavy rare earth metal is coated on the surface of magnet, followed by diffusion. Dysprosium diffusion technique is to attach metal or compound powders containing Dy to the surface of magnet, which serves as a diffusion source, then diffusion heat treatment is processed in a certain temperature region, making rare earth element diffuse to the surface of the crystals of the main phase along grain boundary, achieving the purposes of increasing anisotropy field on surface of crystal grains, improving microstructure of grain boundary and increasing coercive force of magnet. However, in the process of high temperature diffusion treatment of dysprosium diffusion, diffusion thickness is small and the improvement of the properties of magnet is limited.

Therefore, how to produce a high temperature resistant neodymium-iron-boron magnet with relative good high temperature coercive force and relative balance magnetic performance has become one of the focuses of neodymium-iron-boron magnet manufacturers and front-line researchers in the field.

### SUMMARY

In view of above, the technical problem to be solved by the present disclosure is to provide a neodymium-iron-boron magnet and a method for producing the same, especially a high temperature resistant neodymium-iron-boron magnet. The neodymium-iron-boron magnet provided by the present disclosure has relative good high temperature coercive force as well as balance magnetic properties. In addition, the method is simple and easy, suitable for large-scale industrial production.

The present disclosure provides a neodymium-iron-boron magnet, which is obtained by processing neodymium-iron-boron raw material powders coated with modified powders, wherein the modified powders comprise heavy rare earth element oxide powders and/or heavy rare earth element fluoride powders.

Preferably, the ratio of average particle size of the neodymium-iron-boron raw material powders to average particle size of the modified powders is (50 to 200):1.

Preferably, the heavy rare earth elements include dysprosium and/or terbium.

Preferably, the mass percentage of the modified powders in the total mass of the neodymium-iron-boron magnet is up to 4%.

Preferably, the neodymium-iron-boron raw material powders comprise, by mass percentage,

Pr—Nd: 28% to 33%; Dy: 0 to 10%; Tb: 0 to 10%; Nb: 0 to 5%; B: 0.5% to 2.0%; Al: 0 to 3.0%; Cu: 0 to 1%; Co: 0 to 3%; Ga: 0 to 2%; Gd: 0 to 2%; Ho: 0 to 2%; Zr: 0 to 2%; the balance is Fe.

Preferably, the neodymium-iron-boron raw material powders only comprise the powders by which the obtained magnet has a medium-high intrinsic coercive force more than or equal to 17 kOe.

The present disclosure also provides a method for producing the neodymium-iron-boron magnet, comprising,

A) mixing the pulverized neodymium-iron-boron raw material powders and the modified powders at high speed to obtain modified neodymium-iron-boron raw material powders;

the modified powders comprise heavy rare earth element oxide powders and/or heavy rare earth element fluoride powders; and

B) pressing and sintering the modified neodymium-iron-boron raw material powders obtained in the above step to obtain the neodymium-iron-boron magnet.

Preferably, the duration of the high speed mixing is between 0.1 and 2 hours; and the speed of the high speed mixing is between 80 and 220 rpm.

Preferably, the temperature of the sintering is between 1030 and 1090° C.;

the duration of the sintering is between 3 and 10 hours; and

further comprising aging treatment after the sintering.

Preferably, the aging treatment comprises a first annealing aging treatment and a second annealing aging treatment;

the temperature of the first annealing aging treatment is between 800 and 950° C.; the duration of the first annealing aging treatment is between 3 and 10 hours; and

the temperature of the second annealing aging treatment is between 400 and 550° C.; the duration of the second annealing aging treatment is between 3 and 10 hours.

The present disclosure provides a neodymium-iron-boron magnet which is obtained by processing neodymium-iron-boron raw material powders coated with modified powders; the modified powders comprise heavy rare earth oxide and/or heavy rare earth fluoride. The present disclosure is to solve the problems of the conventional art, for example, in the conventional art, heavy rare earth elements are used to substitutes the light rare earth elements, leading to the decrease of remanent flux density Br, and the use amount is large. In addition, the diffusion thickness in the dysprosium diffusion is small and the improvement of the magnet properties is limited. Comparing with the conventional art, the present disclosure solves the above problems. In numerous steps of the method for producing the magnet, the present disclosure creatively starts from magnet powders and specially uses heavy rare earth fluoride or oxide to coat on the surface of the magnetic powder particles, so that diffusion occurs simultaneously during the subsequent sintering process. In addition, during the sintering process, the heavy rare earth oxide or fluoride powders coated on the surface of the magnetic powders substitute part of the light rare earth and the heavy rare earth is absorbed by the magnets, thereby increasing coercive force and effectively inhibiting the reduction of the residual magnetism. The present disclosure employs heavy rare earth oxide or fluoride as diffusion source, which are coated on the surface of the magnetic powder particles before sintering. With a small amount of heavy rare earth material, the coercive force of the magnet is improved significantly, which saves the heavy rare earth source and reduces the production cost. At the same time, comparing with conventional dysprosium diffusion, the process of the present disclosure is simple and the size of magnets is not limited.

Experiment results show that, comparing with the same grade of neodymium-iron-boron magnets on the market, in the present disclosure, the coercive force of the present neodymium-iron-boron magnet by adding modified powders increases by 85%, and the residual magnetism and the maximum magnetic energy product substantially remain the same.

### DETAILED DESCRIPTION

In order to further illustrate the technical solution of the present disclosure, the preferred embodiments of the present disclosure are described hereinafter in conjunction with the examples of the present disclosure. It is to be understood that the description is merely illustrating the characters and advantages of the present disclosure, and is not intended to limit the claims of the present application.

There is no special restriction to the source of all of the raw materials of the present disclosure, which can be purchased on the market or prepared by the method well-known to one of ordinary skill in the art.

There is no special restriction to the purity of all the raw materials of the present disclosure, and analytically grade or routine purity being used in the field of neodymium-iron-boron magnet is preferred in the present disclosure.

The present disclosure provides a neodymium-iron-boron magnet, which is obtained by processing neodymium-iron-boron raw material powders coated with modified powders, wherein

the modified powders comprise heavy rare earth element oxide powders and/or heavy rare earth element fluoride powders.

There is no special restriction to the heavy rare earth element in the present disclosure, which can be the one being used in magnet material by one of ordinary skill in the art. One of ordinary skill can choose and adjust the heavy rare earth element according to actual production condition, requirements of product and quality. The heavy rare earth element of the present disclosure preferably includes dysprosium and/or terbium, more preferably is dysprosium or terbium.

There is no special restriction to the heavy rare earth oxide in the present disclosure, which can be rare earth oxide being used in magnet material by one of ordinary skill in the art. One of ordinary skill can choose and adjust the heavy rare earth oxide according to actual production condition, requirements of product and quality. The heavy rare earth oxide of the present disclosure preferably includes Dy₂O₃, Tb₂O₃ or Tb₄O₇, more preferably is Dy₂O₃ or Tb₂O₃.

There is no special restriction to the heavy rare earth fluoride in the present disclosure, which can be rare earth fluoride being used in magnet material by one of ordinary skill in the art. One of ordinary skill can choose and adjust the heavy rare earth fluoride according to actual production condition, requirements of product and quality. The heavy rare earth fluoride of the present disclosure preferably includes DyF₃ or TbF₃.

There is no special restriction to the addition amount of the modified powders in the present disclosure, which can be the amount being used in magnet material by one of ordinary skill in the art. One of ordinary skill can choose and adjust the amount according to actual production condition, requirements of product and quality. The mass ratio of the modified powders to the total mass of the neodymium-iron-boron magnet is preferably up to 4%, more preferably 0.01% to 4%, more preferably 0.1% to 3.5%, more preferably 1% to 3%, and most preferably 1.5% to 2.5%.

There is no special restriction to particle size of the modified powders, which can be routine particle size being used in magnet material by one of ordinary skill in the art. One of ordinary skill can choose and adjust the particle size according to actual production condition, requirements of product and quality. The modified powders of the present disclosure is preferably nano-scale modified powders, and the specific particle size is preferably from 10 to 300 nm, more preferably from 20 to 250 nm, more preferably 30 to 200 nm, more preferably 50 to 150 nm, and most preferably from 60 to 100 nm.

There is no special restriction to the ratio of average particle size of the neodymium-iron-boron raw material powders to average particle size of the modified powders, which can be routine particle size ratio being used in magnet material by one of ordinary skill in the art. One of ordinary skill can choose and adjust the ratio according to actual production condition, requirements of product and quality. In the present disclosure, in order to improve coating effect, and further ensure magnetic properties of the product, the ratio of average particle size of the neodymium-iron-boron raw material powders to average particle size of the modified powders is preferably (50 to 200):1, more preferably (75 to 175):1, and most preferably (100 to 150):1.

There is no special restriction to the definition of the average particle size, which can be routine average particle size being used in magnet material by one of ordinary skill in the art. One of ordinary skill can choose and adjust the average particle size according to actual production condition, requirements of product and quality. The average particle size of the present disclosure is preferably surface mean diameter (SMD).

There is no special restriction to the composition of the neodymium-iron-boron raw material powders, which can be composition of neodymium-iron-boron raw material powders being used by one of ordinary skill in the art. One of ordinary skill can choose and adjust the composition of the neodymium-iron-boron raw material powders according to actual production condition, requirements of product and quality. In the present disclosure, components of the neodymium-iron-boron raw material powders preferably comprise, by mass percentage, Pr—Nd: 28% to 33%, Dy: 0 to 10%, Tb: 0 to 10%, Nb: 0 to 5%, B: 0.5% to 2.0%, Al: 0 to 3.0%, Cu: 0 to 1%, Co: 0 to 3%, Ga: 0 to 2%, Gd: 0 to 2%, Ho: 0 to 2%, Zr: 0 to 2%, the balance is Fe; and more preferably Pr—Nd: 28.40% to 33.00%, Dy: 0.50% to 6.0%, Tb: 0.50% to 6.0%, B: 0.92% to 0.98%, Al: 0.10% to 3.0%, Cu: 0.10% to 0.25%, Co: 0.10% to 3.0%, Ga: 0.1% to 0.3%, and the balance is Fe.

There is no special restriction to the specific grade of the neodymium-iron-boron magnet raw materials, which can be the routine grade being used in neodymium-iron-boron magnet by one of ordinary skill in the art. One of ordinary skill can choose and adjust the grade according to actual production condition, requirements of product and quality. In the present disclosure, the neodymium-iron-boron raw material powders only comprise the powders by which the obtained magnet has a medium-high intrinsic coercive force more than or equal to 17 kOe, that is, without the modified powders, the pure neodymium-iron-boron raw material powders will give a magnet with intrinsic coercive force more than or equal to medium-high coercive force 17 kOe, which includes M type neodymium-iron-boron magnet (medium coercive force), H type neodymium-iron-boron magnet (high coercive force), SH type neodymium-iron-boron magnet (super high coercive force), UH type neodymium-iron-boron magnet (ultra-high coercive force), or EH type neodymium-iron-boron or AH type neodymium-iron-boron magnet (extremely high coercive force). In the present disclosure, H type neodymium-iron-boron magnet raw material, SH type neodymium-iron-boron magnet raw material or UH neodymium-iron-boron magnet raw material are preferred, more preferably SH type neodymium-iron-boron magnet raw material. Specifically, neodymium-iron-boron magnets of 42SH, 45SH or 40UH grade are used, and preferably 42SH.

The present disclosure also provides a method for producing neodymium-iron-boron magnet, comprising,

A) mixing pulverized neodymium-iron-boron raw material powders and modified powders at high speed to obtain modified neodymium-iron-boron raw material powders;

the modified powders comprise heavy rare earth element oxide powders and/or heavy rare earth element fluoride powders; and

B) pressing and sintering the modified neodymium-iron-boron raw material powders obtained in step A) to obtain the neodymium-iron-boron magnet.

In the method of the present disclosure above, principles of choice and optimization of the raw materials, ratio and other parameters are the same as the principles of choice and optimization of raw materials, ratio and other parameters of the neodymium-iron-boron magnet above, which is not repeated herein.

In the present disclosure, the pulverized neodymium-iron-boron raw material powders and the modified powders are mixed at high speed firstly to obtain a modified neodymium-iron-boron raw material powders.

There is no special restriction to the pulverized neodymium-iron-boron raw material powders in the present disclosure, which can be neodymium-iron-boron raw material powders from the routine preparation process of neodymium-iron-boron raw material powders well-known to one of ordinary skill in the art. One of ordinary skill can choose and adjust the powders according to actual production condition, requirements of product and quality. The pulverized neodymium-iron-boron raw material powders of the present disclosure is preferably the neodymium-iron-boron raw material fine powder obtained after one step or several steps of dosing, melting, decrepitation, pulverizing, hydrogen decrepitation and so on.

There is no special restriction to the particle size of the neodymium-iron-boron raw material powders in the present disclosure, which can be routine particle size being used in magnet preparation by one of ordinary skill in the art. One of ordinary skill can choose and adjust the particle size according to actual production condition, requirements of product and quality. The average particle size of the neodymium-iron-boron raw material powders of the present disclosure is preferably from 1.0 to 5.0 μm, more preferably from 1.5 to 4.5 μm, and most preferably from 2.0 to 3.0 μm.

There is no special restriction to the duration of high speed mixing in the present disclosure, which can be routine mixing time well-known to one of ordinary skill in the art. One of ordinary skill can choose and adjust the duration according to actual production condition, requirements of product and quality. Duration of the high speed mixing of the present disclosure is preferably from 0.1 to 2 hours, more preferably from 0.5 to 1.5 hours, more preferably from 5 to 60 minutes, and most preferably from 20 to 45 minutes.

There is no special restriction to the speed of high speed mixing in the present disclosure, which can be routine mixing speed well-known to one of ordinary skill in the art. One of ordinary skill can choose and adjust according to actual production condition, requirements of product and quality. Rotating speed of the high speed mixing of the present disclosure is preferably from 80 to 220 rpm, more preferably from 100 to 200 rpm, and most preferably from 120 to 180 rpm.

There is no special restriction to the particle size of the modified neodymium-iron-boron raw material powders in the present disclosure, which can be routine particle size being used in magnet preparation by one of ordinary skill in the art. One of ordinary skill can choose and adjust the particle size according to actual production condition, requirements of product and quality. Average particle size of the modified neodymium-iron-boron raw material powders of the present disclosure is preferably from 1.0 to 5.0 μm, more preferably from 1.5 to 4.5 μm, and most preferably from 2.0 to 3.0 μm.

In the present disclosure, the modified neodymium-iron-boron raw material powders obtained in the above steps are subjected to pressing and sintering to give the neodymium-iron-boron magnet.

There is no special restriction to pressing method in the present disclosure, which can be pressing method of neodymium-iron-boron raw material powders well-known to one of ordinary skill in the art. One of ordinary skill can choose and adjust the pressing method according to actual production condition, requirements of product and quality. The pressing of the present disclosure includes orientation pressing and isostatic pressing, more preferably orientation pressing under protection of nitrogen or inert gas and followed by oil isostatic pressing.

There is no special restriction to the sintering time in the present disclosure, which can be sintering time of neodymium-iron-boron magnet well-known to one of ordinary skill in the art. One of ordinary skill can choose and adjust the sintering time according to actual production condition, requirements of product and quality. The sintering time of the present disclosure is preferably from 3 to 10 hours, more preferably from 4 to 9 hours, more preferably from 5 to 8 hours, and most preferably from 6 to 7 hours.

There is no special restriction to sintering temperature in the present disclosure, which can be sintering temperature of neodymium-iron-boron magnet well-known to one of ordinary skill in the art. One of ordinary skill can choose and adjust the sintering temperature according to actual production condition, requirements of product and quality. The sintering temperature of the present disclosure is preferably from 1030 to 1090° C., more preferably from 1040 to 1080° C., and most preferably from 1050 to 1070° C.

In order to improve magnetic performance of the product, complete and optimize technological process, aging treatment is also carried out after sintering.

There is no special restriction to specific processes and steps of the aging treatment in the present disclosure, which can be thermal treatment well-known to one of ordinary skill in the art. The aging treatment of the present disclosure preferably comprises a first annealing aging treatment and a second annealing aging treatment.

There is no special restriction to specific temperature of the first annealing aging treatment in the present disclosure, which can be temperature for the aging treatment well-known to one of ordinary skill in the art. One of ordinary skill can choose and adjust the temperature according to actual production condition, requirements of product and quality. Temperature for the first annealing aging treatment of the present disclosure is preferably from 800 to 950° C., more preferably from 825 to 925° C., and most preferably from 850 to 900° C.

There is no special restriction to specific time of the first annealing aging treatment in the present disclosure, which can be aging treatment time well-known to one of ordinary skill in the art. One of ordinary skill can choose and adjust the time according to actual production condition, requirements of product and quality. Time of the first annealing aging treatment is preferably from 3 to 10 hours, more preferably from 4 to 9 hours, more preferably from 5 to 8 hours, and most preferably from 6 to 7 hours.

There is no special restriction to specific temperature of the second annealing aging treatment in the present disclosure, which can be temperature for the aging treatment well-known to one of ordinary skill in the art. One of ordinary skill can choose and adjust the temperature according to actual production condition, requirements of product and quality. Temperature for the second annealing aging treatment of the present disclosure is preferably from 400 to 550° C., more preferably from 425 to 525° C., and most preferably from 450 to 500° C.

There is no special restriction to specific time of the second annealing aging treatment in the present disclosure, which can be aging treatment time well-known to one of ordinary skill in the art. One of ordinary skill can choose and adjust the time according to actual production condition, requirements of product and quality. Time of the second annealing aging treatment is preferably from 3 to 10 hours, more preferably from 4 to 9 hours, more preferably from 5 to 8 hours, and most preferably from 6 to 7 hours.

There is no special restriction to other conditions of sintering and aging treatment in the present disclosure, which can be conditions of magnet sintering and aging treatment well-known to one of ordinary skill in the art. In order to improve effect of thermal treatment, sintering and aging treatment is preferred to carry out under protective atmosphere or vacuum. There is no special restriction to equipment of the sintering and aging treatment, which can be thermal treatment equipment for magnet well-known to one of ordinary skill in the art. Vacuum sintering furnace is preferred in the present disclosure.

In order to further complete and optimize the technological process, post-processing processes may be further included in the present disclosure after the above steps, for example, cleaning, slicing and so on, which is not specially limited. One of ordinary skill can choose and adjust the steps according to actual production condition, requirements of product and quality.

The present disclosure provides a neodymium-iron-boron magnet, which is obtained by processing neodymium-iron-boron raw material powders coated with modified powders, wherein the modified powders comprise heavy rare earth element oxide powders and/or heavy rare earth element fluoride powders. The present disclosure also provides a method for producing neodymium-iron-boron magnet, comprising the following steps: mixing the pulverized neodymium-iron-boron raw material powders and the modified powders at high speed to obtain modified neodymium-iron-boron raw material powders; the modified powders comprise heavy rare earth element oxide powders and/or heavy rare earth element fluoride powders; and pressing and sintering the modified neodymium-iron-boron raw material powders obtained in the above step to obtain the neodymium-iron-boron magnet. In numerous steps of the method for producing the magnet, the present disclosure creatively starts from magnet powders and specially uses heavy rare earth fluoride or oxide to coat on the surface of the magnetic powder particles, so that diffusion occurs simultaneously during the subsequent sintering process. In addition, during the sintering process, the heavy rare earth oxide or fluoride powders coated on the surface of the magnetic powders substitute part of the light rare earth and the heavy rare earth is absorbed by the magnets, thereby increasing coercive force and effectively inhibiting the reduction of the residual magnetism.

Furthermore, in the present disclosure, prefers nano-scale heavy rare earth oxide or fluoride is preferred as the diffusion source, which has been coated on surface of the magnetic powder particles before sintering. More preferably, particle diameter of the magnetic powders (D) and diameter of the modified powders (d) meet the requirement of 50≤D/d≤200, ensuring the effective coating of rare earth fluoride or oxide. In the present disclosure, the particle coating is completed during pulverizing process, and diffusion is carried out during sintering process, reducing the coating and diffusion steps, and diffusion is completed during sintering process. Part of light rare earth is substituted during sintering process, therefore, by using small amount of heavy rare earth element, the coercive force of magnets is increased, which saves rare earth metal sources and production cost. At the same time, comparing with conventional diffusion technique of heavy rare earth oxide or fluoride, the method provided by the present disclosure is simpler and there is no limit to the size of magnet.

Experiment results show that, comparing with the same grade of neodymium-iron-boron magnets on the market, in the present disclosure, the coercive force of the present neodymium-iron-boron magnet by adding modified powders increases by 85%, and the residual magnetism and the maximum magnetic energy product substantially remain the same.

In order to further illustrate the present disclosure, a neodymium-iron-boron magnet and a method for producing the same provided by the present disclosure will be described in detail in conjunction with embodiments. But it should be understood that these embodiments are carried out under the premise of the technical solutions of the present disclosure. Detailed implement plans and specific operation processes are given to further illustrate the features and advantages of the present disclosure, and are not tended to limit the claims of the present disclosure. The protection scope of the present disclosure is also not limited to the embodiments hereinafter.

### Comparative Experiment 1

42SH alloy was smelted, in which the mass ratio of the composition is PrNd30-Dy0.3-Al0.4-Cu0.1-B0.95-Fe (the balance). The alloy was pulverized into fine powders of about 3 microns by hydrogen decrepitation or jet mill pulverization. Afterwards, the fine powders were made into square green-compact (semi-finished product). Then the semi-finished product was disposed in a sintering graphite box and the graphite box with product was put into a sintering furnace. High temperature treatment was performed under vacuum of below 10⁻² Pa at 1050° C. for 8 hours. Thereafter, low temperature tempering (second thermal treatment) was carried out at 510° C. for 5.5 hours to give the neodymium-iron-boron magnet.

The magnetic performances of the neodymium-iron-boron magnet obtained in Comparative Example 1 of the present disclosure were measured at room temperature and the specific results were shown in Table 1. Table 1 showed magnetic performance data of the neodymium-iron-boron magnet prepared in Comparative Example 1 and the neodymium-iron-boron magnets prepared in examples 1 to 3.

The magnetic performances of the neodymium-iron-boron magnet obtained in Comparative Example 1 of the present disclosure were measured at high temperature and the specific results were shown in Table 2. Table 2 showed magnetic performance data of the neodymium-iron-boron magnet prepared in Comparative Example 1 and the neodymium-iron-boron magnets prepared in examples 1 to 3 at high temperature (150° C.).

### Example 1

100% of TbF3 powders and the neodymium-iron-boron raw material fine powders after jet milling (same composition as that of Comparative Example 1) were added into a high speed stirrer at a ratio of 1:99 and subjected to high speed stirring.

The mixture after stirring was pressed to make square green compact (semi-finished product) and then the semi-finished product was dispose in a sintering graphite box. The graphite box with product was put into a sintering furnace and subjected to high temperature thermal treatment under vacuum of below 10⁻² Pa at 1050° C. for 8 hours. Thereafter, low temperature tempering (second thermal treatment) was performed at 510° C. for 5.5 hours to give the neodymium-iron-boron magnet.

The magnetic performances of the neodymium-iron-boron magnet obtained in Example 1 of the present disclosure were measured at room temperature and the specific results were shown in Table 1. Table 1 showed magnetic performance data of the neodymium-iron-boron magnet prepared in Comparative Example 1 and the neodymium-iron-boron magnets prepared in examples 1 to 3.

The magnetic performances of the neodymium-iron-boron magnet obtained in Example 1 of the present disclosure were measured at high temperature and the specific results were shown in Table 2. Table 2 showed magnetic performance data of the neodymium-iron-boron magnet prepared in Comparative Example 1 and the neodymium-iron-boron magnets prepared in examples 1 to 3 at high temperature (150° C.).

### Example 2

100% of TbF₃ powders and the neodymium-iron-boron raw material fine powders after jet milling (same composition as that of Comparative Example 1) were added into a high speed stirrer at a ratio of 2:98 and subjected to high speed stirring.

The mixture after stirring was pressed to make square green compact (semi-finished product) and then the semi-finished product was dispose in a sintering graphite box. The graphite box with product was put into a sintering furnace and subjected to high temperature thermal treatment under vacuum of below 10⁻² Pa at 1050° C. for 8 hours. Thereafter, low temperature tempering (second thermal treatment) was performed at 510° C. for 5.5 hours to give the neodymium-iron-boron magnet.

The neodymium-iron-boron magnet obtained in Example 2 of the present disclosure was subjected to normal temperature magnetic performance detection and the specific results were shown in Table 1. Table 1 showed magnetic performance data of neodymium-iron-boron magnet prepared in Comparative Example 1 and neodymium-iron-boron magnet prepared in examples 1 to 3.

The neodymium-iron-boron magnet obtained in Example 2 of the present disclosure was subjected to high temperature magnetic performance detection and the specific results were shown in Table 2. Table 2 showed high temperature (150° C.) magnetic performance data of neodymium-iron-boron magnet prepared in Comparative Example 1 and neodymium-iron-boron magnet prepared in examples 1 to 3.

### Example 3

100% of TbF₃ powders and the neodymium-iron-boron raw material fine powders after jet milling (same composition as that of Comparative Example 1) were added into a high speed stirrer at a ratio of 3:97 and subjected to high speed stirring.

The mixture after stirring was pressed to make square green compact (semi-finished product) and then the semi-finished product was dispose in a sintering graphite box. The graphite box with product was put into a sintering furnace and subjected to high temperature thermal treatment under vacuum of below 10⁻² Pa at 1050° C. for 8 hours. Thereafter, low temperature tempering (second thermal treatment) was performed at 510° C. for 5.5 hours to give the neodymium-iron-boron magnet.

The neodymium-iron-boron magnet obtained in Example 3 of the present disclosure was subjected to normal temperature magnetic performance detection and the specific results were shown in Table 1. Table 1 showed magnetic performance data of neodymium-iron-boron magnet prepared in Comparative Example 1 and neodymium-iron-boron magnet prepared in examples 1 to 3.

TABLE 1
Magnetic performance data of the neodymium-iron-boron magnet
obtained in examples 1 to 3 and Comparative Example 1

| | Modified | | | |
|---|---|---|---|---|
| | powders:Neo- | | | |
| | dymium-iron- | | | |
| | boron Powder | Br(kGs) | Hcj(kOe) | (BH)max(MGOe) |
| Comparative | 0 | 13.21 | 19.55 | 42.06 |
| Example 1 | | | | |
| Example 1 | 1:99 | 13.15 | 26.87 | 41.98 |
| Example 2 | 2:98 | 13.10 | 30.18 | 41.92 |
| Example 3 | 3:97 | 13.10 | 36.15 | 41.86 |

As shown in Table 1, the neodymium-iron-boron magnet, in which heavy rare earth had been added during 42SH smelting, has a coercive force of only 19.55; while the coercive force of the modified neodymium-iron-boron magnets of examples 1 to 3 of the present application was improved significantly, and the residual magnetism and magnetic energy product basically showed no decrease.

The neodymium-iron-boron magnet obtained in Example 3 of the present disclosure was subjected to high temperature magnetic performance detection and the specific results were shown in Table 2. Table 2 showed high temperature (150° C.) magnetic performance data of neodymium-iron-boron magnet prepared in Comparative Example 1 and neodymium-iron-boron magnet prepared in examples 1 to 3.

TABLE 2

| | Modified | | | |
|---|---|---|---|---|
| | powders:Neo- | | | |
| | dymium-iron- | | | |
| | boron Powder | Br(kGs) | Hcj(kOe) | (BH)max(MGOe) |
| Comparative | 0 | 11.22 | 6.15 | 29.83 |
| Example 1 | | | | |
| Example 1 | 1:99 | 11.26 | 10.77 | 30.19 |
| Example 2 | 2:98 | 11.29 | 13.35 | 30.49 |
| Example 3 | 3:97 | 11.35 | 17.02 | 30.78 |

As shown in Table 2, the neodymium-iron-boron magnet, in which heavy rare earth had been added during 42SH smelting, has a coercive force of only 6.55 at a high temperature of 150° C.; while the modified neodymium-iron-boron magnets in examples 1 to 3 of the present application have significant good coercive force, residual magnetism and magnetic energy at high temperature of 150° C.

A high temperature resistant neodymium-iron-boron magnet and the method for producing the same of the present disclosure is described in detail above, and specific examples are used in the article to illustrate the principles and embodiments of the present disclosure. The examples of the present invention provided is to help people understanding the method and core concept of the present disclosure, including the best mode, so one of ordinary skill in the art can practice the present disclosure, for example, making and using the equipment or system, and combining with any of other methods in practice. It should be noted that, to those of ordinary skill in the art, improvements and modifications can be made without departing from the principles of the present disclosure, and such improvements and modifications all fall in the protection extent of the claims of the present disclosure. The scope of the present disclosure is defined by the claims and it also includes other embodiments that can be contemplated by the skilled person in the art. Other embodiments which have equivalent structural elements that are not substantially different from the literal representation of the claims, are to be included within the scope of the claims.

1. A neodymium-iron-boron magnet, obtained by processing neodymium-iron-boron raw material powders coated with modified powders, wherein
the modified powders comprise heavy rare earth element oxide powders and/or heavy rare earth element fluoride powders.

2. The neodymium-iron-boron magnet according to claim 1, wherein the ratio of average particle size of the neodymium-iron-boron raw material powders to average particle size of the modified powders is (50 to 200):1.

3. The neodymium-iron-boron magnet according to claim 1, wherein the heavy rare earth element includes dysprosium and/or terbium.

4. The neodymium-iron-boron magnet according to claim 1, wherein the mass percentage of the modified powders in the total mass of the neodymium-iron-boron magnet is up to 4%.

5. The neodymium-iron-boron magnet according to claim 1, wherein the neodymium-iron-boron raw material powders comprise, by mass percentage,
Pr—Nd: 28% to 33%; Dy: 0 to 10%; Tb: 0 to 10%; Nb: 0 to 5%; B: 0.5% to 2.0%; Al: 0 to 3.0%; Cu: 0 to 1%; Co: 0 to 3%; Ga: 0 to 2%; Gd: 0 to 2%; Ho: 0 to 2%; Zr: 0 to 2%; the balance is Fe.

6. The neodymium-iron-boron magnet according to claim 1, wherein the neodymium-iron-boron raw material powders only comprise the powders by which the obtained magnet has a medium-high intrinsic coercive force of 17 kOe or more.

7. A method for producing a neodymium-iron-boron magnet, comprising
A) mixing neodymium-iron-boron raw material powders after pulverization and modified powders at high speed to obtain modified neodymium-iron-boron raw material powders;
the modified powders comprise heavy rare earth element oxide powders and/or heavy rare earth element fluoride powders; and
B) pressing and sintering the modified neodymium-iron-boron raw material powders obtained in step A) to obtain the neodymium-iron-boron magnet.

8. The method according to claim 7, wherein
the duration of the high speed mixing is between 0.1 and 2 hours; and
the speed of the high speed mixing is between 80 and 220 rpm.

9. The method according to claim 7, wherein
the temperature of the sintering is between 1030 and 1090° C.;
the duration of the sintering is between 3 and 10 hours; and
further comprising aging treatment after the sintering.

10. The method according to claim 9, wherein
the aging treatment comprises a first annealing aging treatment and a second annealing aging treatment;
the temperature of the first annealing aging treatment is between 800 and 950° C.; the duration of the first annealing aging treatment is between 3 and 10 hours; and
the temperature of the second annealing aging treatment is between 400 and 550° C.; the duration of the second annealing aging treatment is between 3 and 10 hours.
